(19) United States
(12) Patent Application Publication
(10) Pub. No.: US 2012/0140134 A1
(43) Pub. Date: Jun. 7, 2012

(54) DISPLAY PANEL USING FLEXIBILITY OF METAL THIN FILM PATTERNS AND FABRICATING METHOD THEREOF

(76) Inventor: Heon Young Lee, Seoul (KR)

(21) Appl. No.: 13/375,758

(22) PCT Filed: Jun. 3, 2010
(86) PCT No.: PCT/KR2010/003582

§ 371 Date: Feb. 17, 2012

(30) Foreign Application Priority Data
Jun. 5, 2009 (KR) 10-2009-0049722

(51) Int. Cl. G02F 1/133; H01J 9/24

(52) U.S. Cl. 349/33; 445/24

(57) ABSTRACT

The present invention relates to a display panel using flexibility of metal thin film patterns and a fabricating method thereof, and more particularly, to a display panel using flexibility of metal thin film patterns and a fabricating method thereof, in which, by using a characteristic in which the metal thin film patterns may be deformed depending on a potential difference, the display panel is configured so that light emitted from a back light unit is reflected or transmitted by means of the deformed metal thin film patterns and then emitted to the outside of the display panel, thereby capable of improving light transmittance and saving fabrication cost of the display panel.

A display panel using flexibility of metal thin film patterns according to the present invention includes a first substrate; a light shield layer pattern formed in a lattice shape on top of the first substrate; a transparent layer formed on top of the light shield layer pattern and the first substrate; a plurality of metal thin film patterns formed on light transmitting regions formed in between the lattice-shaped light shield layer pattern, wherein the metal thin film pattern has one portion connected onto the transparent layer and the other portion formed to be spaced apart from the transparent layer at a predetermined distance; and a second substrate provided to be spaced upward from the first substrate at a predetermined distance, wherein an opposite electrode pattern is formed under the second substrate, wherein when an electric field is applied between the plurality of metal thin film patterns and the opposite electrode pattern, the plurality of metal thin film patterns are deformed by a potential difference formed between the plurality of metal thin film patterns and the opposite electrode pattern.

### BACKGROUND OF THE INVENTION

1. Field of the Invention

The present invention relates to a display panel using flexibility of metal thin film patterns and a fabricating method thereof, and more particularly, to a display panel using flexibility of metal thin film patterns and a fabricating method thereof, in which, by using a characteristic in which the metal thin film patterns may be deformed depending on a potential difference, the display panel is configured so that light emitted from a back light unit is reflected or transmitted by means of the deformed metal thin film patterns and then emitted to the outside of the display panel, thereby capable of improving light transmittance and saving fabrication cost of the display panel.

2. Description of the Related Art

With the rapid development of semiconductor technologies, demand for small and light flat panel displays with improved performance has been explosively increased. Since liquid crystal displays (LCDs) among these flat panel displays have advantages of miniaturization, light weight, low power consumption and the like, the LCDs have gradually come into the spotlight as an alternative means capable of overcoming the disadvantages of existing cathode ray tubes (CRTs). Currently, the LCDs have been used to be installed in not only small products such as cellular phones and portable digital assistants (PDAs) but also medium- and large-sized products such as monitors and TVs, which require flat panel displays.

A conventional LCD is a display device having a structure in which a liquid crystal panel is formed by injecting liquid crystals between two transparent substrates, and a back light unit for irradiating light toward the liquid crystal panel is attached to one surface of the liquid crystal panel. In the LCD, a specific arrangement of liquid crystal molecules is converted into another arrangement thereof by applying a voltage to the specific arrangement, so that such a converted arrangement of liquid crystal molecules may cause a change in optical characteristics of double refraction, optical rotation, dichroism, light diffusion and the like in a light-emitting liquid crystal cell to be converted into a change in visual sense. That is, the LCD is a display device which may display information using a modulation of light by means of the liquid crystal cell.

FIG. 1 is a sectional view illustrating a structure of a conventional LCD. The LCD includes a liquid crystal display panel (LCD panel) having a first substrate 10, on which thin film transistors (hereinafter, referred to as TFTs) 13 arranged in a matrix form and pixel electrodes 12 are formed, a second substrate 20, which is opposite to the first substrate 10 and on which a color filter 22 and an opposite electrode pattern 23 are formed, and a liquid crystal layer 30 interposed between the first and second substrates; a back light unit (BLU) 40 for supplying light to the LCD panel; and a driving module (not shown) for driving the LCD panel and the BLU.

The liquid crystal layer 30 interposed in the LCD panel is composed of molecules having optical anisotropy, and has a characteristic in which, when a voltage is applied, the arrangement of the molecules is changed depending on a direction of an electric field. Hence, the liquid crystal layer 30 can change the polarization of light depending on whether the voltage is applied. In order to use the characteristic of the liquid crystal layer 30, polarizing plates 11 and 21 are provided onto top and bottom portions of the LCD panel, respectively, so that light may be transmitted through or blocked from the LCD panel, thereby displaying an image.

Further, since the LCD panel is a non-luminescent device that cannot emit light autonomously, the LCD panel displays an image by using light supplied from the BLU 40. Since the BLU 40 generally emits white light, a color filter method or a field sequential (FS) driving method may be used so as to implement various colors through the LCD panel. In the color filter method, the color filter 22 composed of three primary colors of red (R), green (G) and blue (B) is formed on one of the first and second substrates constituting the LCD panel, and a desired color may be expressed by controlling the amount of light transmitted through the color filter 22. Meanwhile, in the FS driving method, a persistence of vision in an eye is used to display an image by sequentially displaying light of three primary colors of RGB emitted from RGB backlights on one pixel in a time divisional manner rather than by dividing one pixel into RGB unit pixels.

However, in the conventional LCD, a rubbing process for pre-tilting liquid crystals, a spacer injecting process, a liquid crystal injecting process, and the like are performed before the liquid crystals are injected into the LCD panel. There is a problem in that the rubbing process including a process of forming an alignment groove, a process of forming alignment layers 14 and 24, a cleaning process, a drying process, and the like may increase the total fabrication time of the LCD. Particularly, there is a problem in that fine particles may be generated through the process of forming the alignment groove, so that a failure may occur in a fabrication facility thereof.

Further, light emitted from the BLU 40 passes through a plurality of layers including the polarizing plates 11 and 21, the color filter 22, the liquid crystal layer 30 and the like and is then radiated to the outside of the LCD panel, so that the total light transmittance of the LCD may be deteriorated.

### SUMMARY OF THE INVENTION

An object of the present invention is to provide a display panel using flexibility of metal thin film patterns and a fabricating method thereof, in which the metal thin film patterns are formed between a pair of transparent substrates, and a potential difference generated between the pair of transparent substrates by applying an electric field is used to deform the metal thin film patterns, so that light emitted from a back light unit may be introduced toward bottom or top surfaces of the metal thin film patterns and then reflected by means of an adjacent metal thin film pattern to be emitted to the outside of the display panel or light emitted from the back light unit may be transmitted through a space formed between the metal thin film patterns, thereby improving light transmittance. Further, since high-priced materials need not be used, the fabrication cost may be reduced.

According to an aspect of the present invention, there is provided a display panel using flexibility of metal thin film patterns, the display panel including: a first substrate; a light shield layer pattern formed in a lattice shape on top of the first substrate; a transparent layer formed on top of the light shield layer pattern and the first substrate; a plurality of metal thin film patterns formed on light transmitting regions formed in between the lattice-shaped light shield layer pattern, wherein the metal thin film pattern has one portion connected onto the transparent layer and the other portion formed to be spaced apart from the transparent layer at a predetermined distance; and a second substrate provided to be spaced upward from the first substrate at a predetermined distance, wherein an opposite electrode pattern is formed under the second substrate, wherein when an electric field is applied between the plurality of metal thin film patterns and the opposite electrode pattern, the plurality of metal thin film patterns are deformed by a potential difference formed between the plurality of metal thin film patterns and the opposite electrode pattern.

According to another aspect of the present invention, there is provided a fabricating method of a display panel using flexibility of metal thin film patterns, the method including the steps of: forming a lattice-shape light shield layer pattern on top of a first substrate; forming a transparent layer on top of the light shield layer pattern and the first substrate; forming a sacrificial layer pattern on light transmitting regions of the transparent layer formed in between the lattice-shaped light shield layer pattern; forming a metal thin film pattern on a side surface and a top surface of the sacrificial layer pattern; forming a barrier defining pixel regions on top of the transparent layer; removing the sacrificial layer pattern; and aligning a second substrate on top of the first substrate and bonding them together, wherein an opposite electrode pattern is formed under the second substrate.

In the display panel using flexibility of the metal thin film patterns and the fabricating method thereof according to the present invention, the metal thin film patterns are formed between a pair of transparent substrates, and a potential difference generated between the pair of transparent substrates by applying an electric field is used to deform the metal thin film patterns, so that light emitted from a back light unit may be transmitted or reflected, thereby controlling the light transmittance. Thus, it is possible to improve the light transmittance as compared with an LCD display panel in which light in a predetermined direction is transmitted through several layers and emitted to the outside. Further, since high-priced materials such as a polarizing plate, an alignment layer and liquid crystals need not be used, the fabrication cost may be reduced.

### BRIEF DESCRIPTION OF THE DRAWINGS

FIG. 1 is a sectional view illustrating a structure of a conventional liquid crystal display;

FIGS. 2 to 8 are sectional views illustrating a fabricating method of a display panel using flexibility of metal thin film patterns according to the present invention;

FIGS. 9 to 11 are sectional views illustrating a configuration of a display panel using flexibility of metal thin film patterns according to a first embodiment of the present invention; and

FIG. 12 is a sectional view illustrating a configuration of a display panel using flexibility of metal thin film patterns according to a second embodiment of the present invention.

[Explanation of Reference Numerals for
Major Portions Shown in Drawings]

| | |
|---|---|
| 100: First substrate | 110, 250: Light shield layer pattern |
| 110a, 210: Opposite electrode pattern | 120, 260: Transparent layer |
| 130: Sacrificial layer pattern | 140, 270: Metal thin film pattern |
| 150: Barrier | 200: Second substrate |
| 220, 220a: Color filter | 230, 230a: Black matrix |
| 240: Insulating layer | 300: Back light unit |

### DETAILED DESCRIPTION OF THE INVENTION

Hereinafter, preferred embodiments of the present invention will be described in detail with reference to the accompanying drawings. However, the present invention is not limited to the following embodiments without departing from the spirit and scope of the present invention defined by the appended claims.

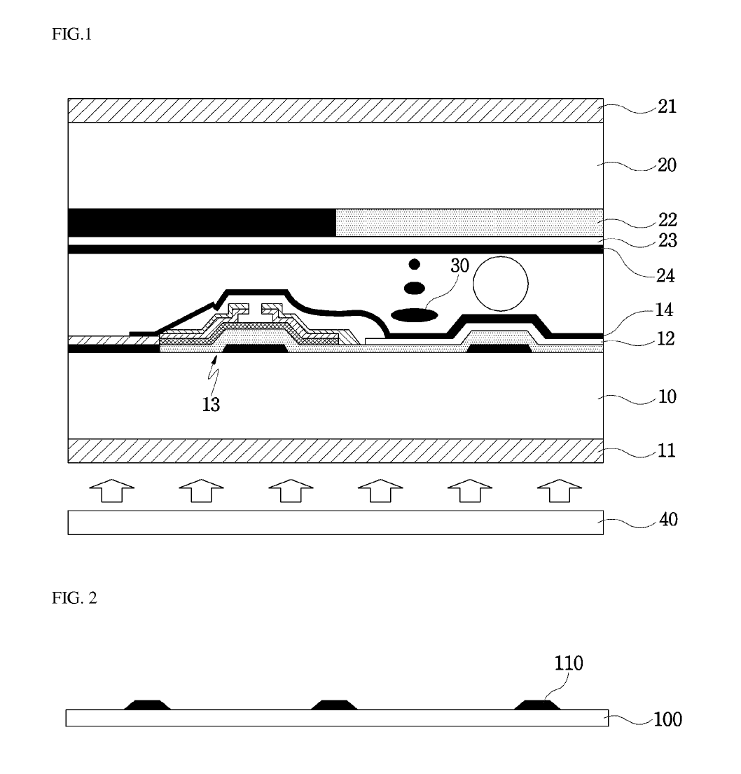

FIGS. 2 to 8 are sectional views illustrating a fabricating method of a display panel using flexibility of metal thin film patterns according to the present invention.

First, a lattice-shaped light shield layer pattern 110 is formed by depositing a light shield layer on top of a first substrate 100 made of a transparent material and then patterning the light shield layer through a photolithography process. The first substrate 100 is a transparent substrate, so that it may be made of a glass substrate, a plastic substrate, or the like. The light shield layer is made of a light absorbing or reflecting material, so that it may be made of a conductor such as aluminum (Al), copper (Cu), molybdenum (Mo), titanium (Ti), chrome (Cr) or an alloy thereof, or an insulator such as an organic or inorganic layer. Light transmitting regions are formed in between the lattice-shaped light shield layer pattern 110 so that light introduced onto the first substrate from a BLU can be transmitted through the light transmitting regions (See FIG. 2).

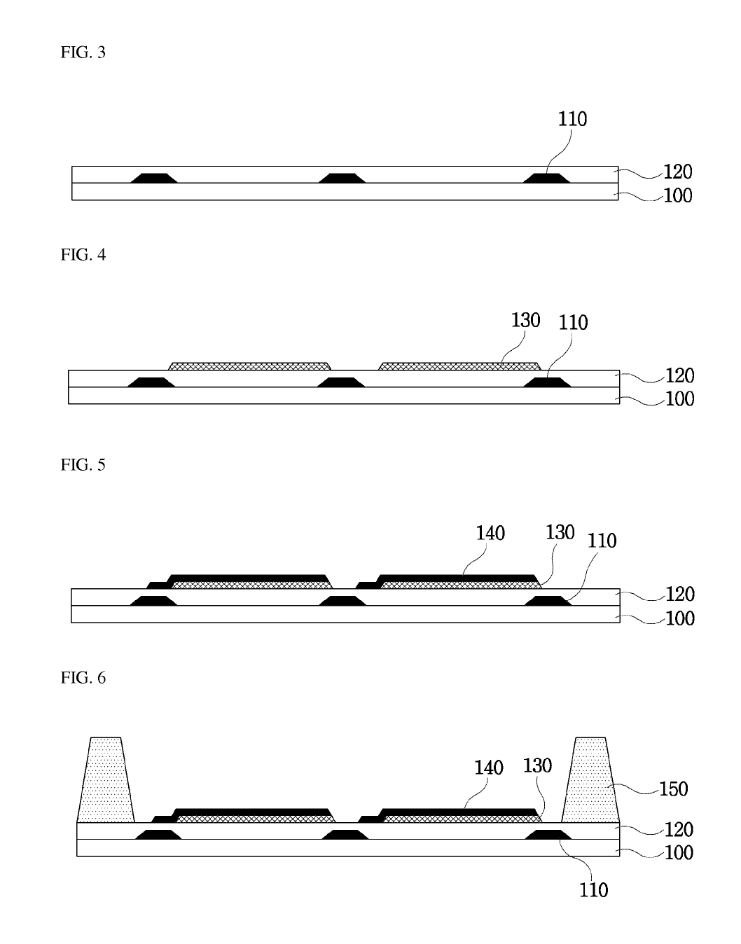

Next, a transparent layer 120 is formed on top of the first substrate 100 and the light shield layer pattern 110. At this time, the transparent layer 120 is an insulating layer, so that the transparent layer 120 may remove a step formed by the light shield layer pattern 110. If the light shield layer pattern 110 is made of a conductive metallic material, the transparent layer 120 serves to insulate the light shield layer pattern 110 from metal thin film patterns 140, which will be formed later. The transparent layer 120 may be formed to have a single-layered structure or a laminated structure, using an oxide layer, an oxynitride layer, a nitride layer, and the like (See FIG. 3).

Subsequently, a sacrificial layer having a predetermined thickness is formed on top of the transparent layer 120, and a sacrificial layer pattern 130 are formed by patterning the sacrificial layer through a photolithography process. The sacrificial layer pattern 130 is formed on the light transmitting regions formed in between the lattice-shaped light shielding pattern 110, using a material with which the etch selectivity of the sacrificial layer is different from that of the transparent layer 120. In the photolithography process, a taper etching process is performed so that a sidewall of the sacrificial layer pattern 130 is configured to have a slope. The taper etching process may cause a step with a predetermined slope to be formed in the metal thin film patterns 140, which will be formed later, thereby facilitating the bending or restoring operation of the metal thin film patterns 140 (See FIG. 4).

Next, a metal thin film is formed on top of the transparent layer 120 and the sacrificial layer pattern 130. At this time, the metal thin film may be formed of Al, Cu, Mo, Ti, Cr or an alloy thereof, which may shield and reflect light. The metal thin film may be formed to have a double or triple laminated structure using the aforementioned materials. If the metal thin film is formed to have the double or triple laminated structure as described above, metal thin films which would form uppermost and lowermost surfaces of the double or triple laminated structure may have a higher reflexibility than any other metal thin films formed between the uppermost and lowermost surfaces, thereby improving the efficiency of light emitted to the outside.

Subsequently, the metal thin film patterns 140 are formed by patterning the metal thin film through a photolithography process. In this case, each metal thin film pattern 140 is formed over a side surface and a top surface of the sacrificial layer pattern 130. One portion of each metal thin film pattern 140 is connected onto the transparent layer 120 through the side surface of the sacrificial layer pattern 130 while the other portion of each metal thin film pattern 140 is formed on top of the sacrificial layer pattern 130 and has a step with a predetermined slope against the one portion of the metal thin film pattern 140 connected onto the transparent layer 120. A plurality of metal thin film patterns 140 may be formed in one pixel region. One direction of the metal thin film patterns, i.e., the respective one portions of the plurality of metal thin film patterns connected onto the transparent layer 120 may be electrically connected to one another. Multiple metal thin film patterns 140 in the single pixel region may be configured to be bent in different directions from one another.

Through such a configuration, the metal thin film patterns 140 are not only used as an electrode but also serve to reflect light introduced onto the first substrate from the BLU to an adjacent metal thin film pattern 140 through the bending or restoring operation of the metal thin film patterns 140 so that the reflected light may be emitted to the outside. The amount of light emitted to the outside may be adjusted by a potential difference applied between the metal thin film patterns 140 and an opposite electrode pattern 210 (See FIG. 5).

Next, a barrier 150 defining pixel regions is formed by forming an insulating layer on top of the entire surface of the first substrate and then patterning the insulating layer through a photolithography process. At this time, the insulating layer may be formed by using a black matrix (BM) material such as a chrome-based metallic material or carbon-based organic material in a photoresist composed of a photopolymerization initiator, a binder resin, polymer monomer and a solvent. When the pixel regions are defined by means of the barrier 150, a plurality of metal thin film patterns 140 electrically connected to one another are allowed to be provided in one pixel region. Many sub-pixels for displaying RGB may be positioned in one pixel region (See FIG. 6).

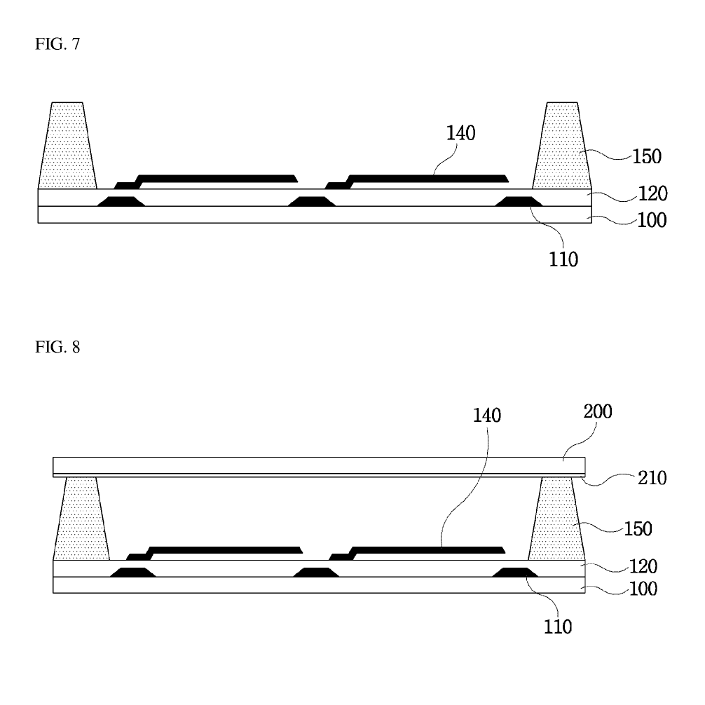

Subsequently, the sacrificial layer pattern 130 formed under the metal thin film patterns 140 is removed through a selective etching process using a difference in etch selectivity of the barrier 150, the metal thin film patterns 140 and the sacrificial layer pattern 130. After the sacrificial layer pattern 130 is removed, the one portion of each metal thin film pattern 140 is connected onto the transparent layer 120 while the other portion of each metal thin film pattern 140 is floated in the state that the other portion is spaced apart from the transparent layer 120 at a predetermined distance. If an electric field is applied between the metal thin film patterns 140 and the opposite electrode pattern 210 through such a configuration, the metal thin film patterns 140 are bent to be deformed by the potential difference between the metal thin film patterns 140 and the opposite electrode pattern 210. Therefore, light emitted from the BLU may be introduced onto a bottom or top surface of each metal thin film pattern 140 so as to be reflected toward a top or bottom surface of an adjacent metal thin film pattern 140 or so as to be transmitted through a space formed between each metal thin film pattern 140 and the light shield layer pattern 110, thereby being emitted to the outside (See FIG. 7).

Subsequently, the process of forming the display panel is completed by aligning and bonding the first substrate 100 and a second substrate 200 to each other, wherein the opposite electrode pattern 210 is formed under the second substrate 200. At this time, the opposite electrode pattern 210 may be formed using Indium Tin Oxide (ITO), Indium Zinc Oxide (IZO) or amorphous ITO, which is a conductor made of a transparent material (See FIG. 8).

As shown in FIG. 10, a color filter 220 composed of red (R), green (G) and blue (B) filters may be additionally formed on the second substrate 200 positioned in the direction in which light introduced from the BLU is reflected or transmitted through the metal thin film patterns 140 and then emitted to the outside, thereby implementing a full-color image. In this case, a black matrix 230 may be formed to prevent deterioration of image quality due to leakage of light between the respective colors of the color filter.

Hereinafter, an embodiment of configuring a display apparatus made of a display panel formed through the fabricating method described above will be described.

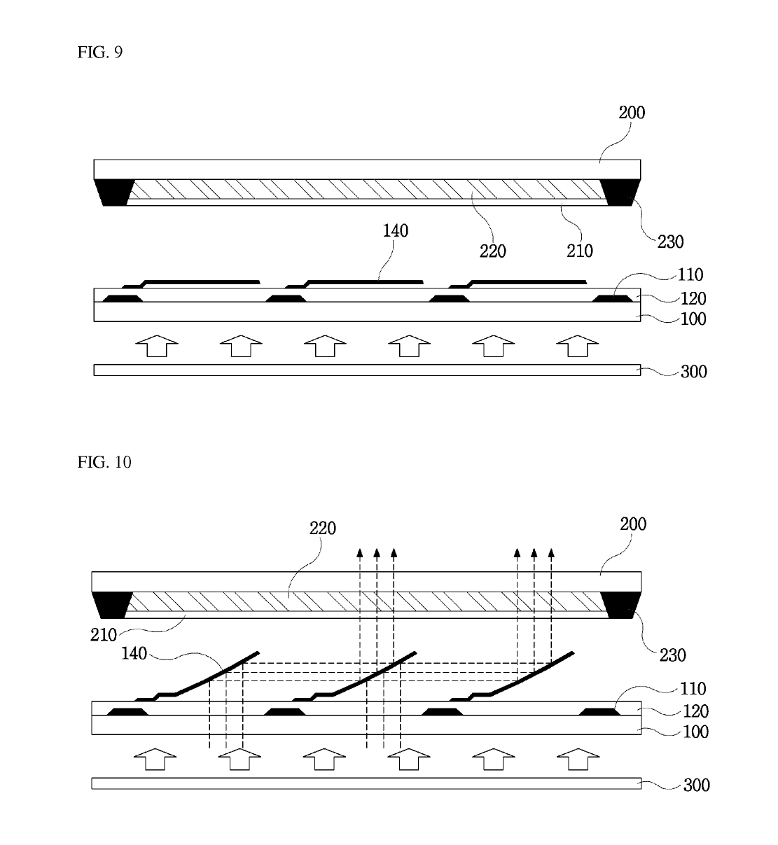

FIGS. 9 to 11 are sectional views illustrating a configuration of a display panel using flexibility of the metal thin film patterns 140 according to a first embodiment of the present invention.

Referring to FIG. 9, a display apparatus made of the display panel using flexibility of the metal thin film patterns according to the first embodiment of the present invention shows a state in which the metal thin film patterns 140 shield light emitted from a BLU 300 when an electric field is not applied between the metal thin film patterns 140 and the opposite electrode pattern 210. In this embodiment, the display panel is configured so that light emitted from the BLU 300 is reflected or transmitted through the metal thin film patterns 140 formed on the first substrate 100 and then emitted to the outside of the display apparatus through the second substrate 200. The color filter 220 is formed between the second substrate 200 and the opposite electrode pattern 210 so that light emitted toward the second substrate 200 can implements a full-color image. The black matrix 230 for preventing deterioration of image quality due to leakage of light between the respective colors of the color filter 220 is formed between adjacent two color filters 220.

Referring to FIG. 10, the display apparatus shows another state in which, when the electric field is applied between the metal thin film patterns 140 and the opposite electrode pattern 210, light emitted from the BLU 300 is introduced onto the bottom surface of the metal thin film pattern 140 bent by the potential difference, and then reflected toward the top surface of an adjacent metal thin film pattern 140, so that it may be emitted to the outside through the second substrate 200.

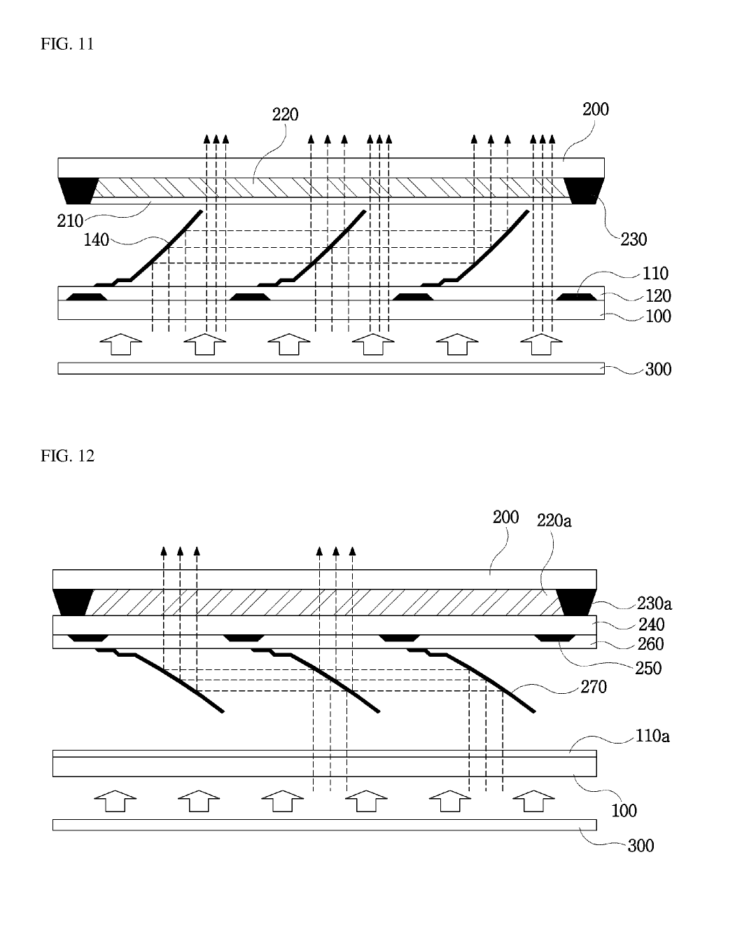

Referring to FIG. 11, the display apparatus shows still another state in which light emitted from the BLU 300 is introduced onto the display panel. Here, when the metal thin film patterns are further bent, a portion of the light is transmitted through the space formed between the bent metal thin film pattern 140 and the light shield layer pattern 110, and the other portion of the light is introduced onto the bottom surface of the metal thin film patterns 140, and then reflected toward the top surface of an adjacent metal thin film pattern 140, so that it may be emitted to the outside through the second substrate 200.

In this case, the degree of bending of the metal thin film patterns 140 is increased by controlling the potential difference formed between the metal thin film patterns 140 and the opposite electrode pattern 210, so that light can be directly transmitted to the space formed between the metal thin film pattern 140 and the light shield layer pattern 110, thereby improving the light transmittance. The degree of bending of the metal thin film patterns 140 can be controlled by increasing or decreasing the potential difference depending on the material of the metal thin film pattern 140.

FIG. 12 is a sectional view illustrating a configuration of a display panel using flexibility of metal thin film patterns according to a second embodiment of the present invention.

Referring to FIG. 12, a display apparatus made of the display panel using flexibility of the metal thin film patterns according to the second embodiment of the present invention has a configuration in which the display panel is formed by sequentially forming a color filter 220a, a black matrix 230a, an insulating layer 240, a light shield layer pattern 250, a transparent layer 260 and metal thin film patterns 270 on the second substrate 200; and then bonding the first substrate 100 onto the second substrate 200, wherein the first substrate 200 is provided with an opposite electrode pattern 110a formed thereon. The display apparatus shows a state in which, when the metal thin film pattern 270 is bent and deformed by applying an electric field between the metal thin film patterns and the opposite electrode pattern, light emitted from the BLU 300 is introduced onto a top surface of the metal thin film pattern 270 through the first substrate 100, and then reflected toward a lower surface of an adjacent metal thin film pattern 270, so that it may be emitted to the outside of the second substrate 200.

The configuration of the second embodiment is different from that of the first embodiment in that the opposite electrode pattern 110a is formed on the first substrate 100, and the metal thin film pattern 270, the color filter 220a and the like are formed on the second substrate 200. Like the first embodiment, by controlling a potential difference formed between the metal thin film pattern 270 and the light shield layer pattern 250, a portion of the light is transmitted through the space between the bent metal thin film pattern 270 and the light shielding pattern 250 while the other portion of the light is reflected toward an adjacent metal thin film pattern 270 and then emitted to the outside through the second substrate 200, so that it is possible to improve light transmittance.

Although the present invention has been described and illustrated in connection with the specific embodiments as described above, it will be readily understood that various modifications can be made thereto without departing from the scope of the present invention. Therefore, the scope of the present invention is not limited to the embodiments described above but is defined by the appended claims and the equivalents thereto.

The display panel using flexibility of metal thin film patterns and the fabricating method thereof according to the present invention can be used to provide a high-quality display to customers at relatively low price in place of the conventional LCD which have been primarily used in the display market.

What is claimed is:

1. A display panel using flexibility of metal thin film patterns, which displays information by allowing light emitted from a back light unit to be introduced thereonto, the display panel comprising:
a first substrate;
a light shield layer pattern formed in a lattice shape on top of the first substrate;
a transparent layer formed on top of the light shield layer pattern and the first substrate;
a plurality of metal thin film patterns formed on light transmitting regions formed in between the lattice-shaped light shield layer pattern, wherein the metal thin film pattern has one portion connected onto the transparent layer and the other portion formed to be spaced apart from the transparent layer at a predetermined distance; and
a second substrate provided to be spaced upward from the first substrate at a predetermined distance, wherein an opposite electrode pattern is formed under the second substrate,
wherein when an electric field is applied between the plurality of metal thin film patterns and the opposite electrode pattern, the plurality of metal thin film patterns are deformed by a potential difference formed between the plurality of metal thin film patterns and the opposite electrode pattern.

2. The display panel according to claim 1, wherein the light shield layer pattern is formed of any one material selected from the group consisting of aluminum (Al), copper (Cu), molybdenum (Mo), titanium (Ti), chrome (Cr), an alloy thereof, an opaque organic layer and an opaque inorganic layer.

3. The display panel according to claim 1, wherein the metal thin film pattern is formed of any one material selected from the group consisting of Al, Cu, Mo, Ti, Cr, and an alloy thereof.

4. The display panel according to claim 1, wherein the metal thin film pattern has a laminated structure formed using two or more materials selected from the group consisting of Al, Cu, Mo, Ti, Cr, and an alloy thereof.

5. The display panel according to claim 1, wherein the portion of the metal thin film pattern connected onto the transparent layer and the other portion thereof formed to be spaced apart from the transparent layer at the predetermined distance are connected to each other by means of a step with a predetermined slope.

6. A fabricating method of a display panel using flexibility of metal thin film patterns, comprising the steps of:
forming a lattice-shape light shield layer pattern on top of a first substrate;
forming a transparent layer on top of the light shield layer pattern and the first substrate;
forming a sacrificial layer pattern on light transmitting regions of the transparent layer formed in between the lattice-shaped light shield layer pattern;
forming a metal thin film pattern on a side surface and a top surface of the sacrificial layer pattern;
forming a barrier defining pixel regions on top of the transparent layer;
removing the sacrificial layer pattern; and
aligning a second substrate on top of the first substrate and bonding them together, wherein an opposite electrode pattern is formed under the second substrate.

7. The method according to claim 6, further comprising the step of forming a color filter between the first substrate and the light shield layer pattern.

8. The method according to claim 6, further comprising the step of forming a color filter between the second substrate and the opposite electrode pattern.

9. The method according to claim 6, wherein the step of forming a sacrificial layer pattern includes the steps of:
forming a sacrificial layer on top of the transparent layer; and
forming a sacrificial layer pattern on the light transmitting regions through a photolithography process,
wherein a taper etching process is performed in the photolithography process so that a slope is formed at a sidewall of the sacrificial layer pattern.

10. The method according to claim 6, wherein the step of removing the sacrificial layer pattern is performed through a selective etching process using a difference in etch selectivity of the metal thin film patterns, the sacrificial layer pattern and the barrier, so that one portion of the metal thin film pattern is connected onto the transparent layer and the other portion of the metal thin film pattern is formed to be spaced apart from the transparent layer at a predetermined distance.
